(19) United States
(12) Patent Application Publication
(10) Pub. No.: US 2010/0055440 A1
(43) Pub. Date: Mar. 4, 2010

(54) COMPOSITE NANOPARTICLES

(75) Inventor: Jin-Kyu Lee, Seoul (KR)

Correspondence Address: FOLEY & LARDNER LLP, 150 EAST GILMAN STREET, P.O. BOX 1497, MADISON, WI, 53701-1497, US

(73) Assignee: Seoul National University Industry Foundation

(21) Appl. No.: 12/199,165

(22) Filed: Aug. 27, 2008

(51) Int. Cl. C04B 35/00; C04B 38/00

(52) U.S. Cl. 428/312.2; 428/404; 65/21.1; 428/325; 428/315.5; 427/397.7; 427/344; 977/811

(57) ABSTRACT

A composite nanoparticle includes a nanoparticle of mineral oxide and a shell of a transition metal oxide. The mineral oxide may be silica, alumina, or a mixture of such materials, and the shell of transition metal oxide at least partially surrounds the nanoparticle of mineral oxide. Methods of preparation include reacting a solution comprising a salt of a transition metal with a nanoparticle of the mineral oxide in the presence of a reducing agent and an organic stabilizing agent; drying the resulting mixture to form a dried mixture; and annealing the dried mixture to form the composite nanoparticle.

### SUMMARY

One aspect is drawn to one or more composite nanoparticles comprising a nanoparticle of mineral oxide and a shell of a transition metal oxide. The mineral oxide is silica, alumina, or a mixture thereof and the shell of transition metal oxide at least partially surrounds the nanoparticle of mineral oxide.

In some aspects, the transition metal oxide is an oxide of Ru, Os, Rh, Ir, Ti, Co, Ni, Rb, Mn, V, or a mixture of any two or more thereof. The diameter of the composite nanoparticle is from about 50 nm to 500 nm.

Another aspect is drawn to one or more methods of preparing the composite nanoparticle, as described above. The method comprises reacting a solution comprising a salt of a transition metal with a nanoparticle of the mineral oxide in the presence of a reducing agent and an organic stabilizing agent, drying the resulting mixture to form a dried mixture and annealing the dried mixture to form the composite nanoparticle.

In some aspects, the salt of the transition metal is a salt of Ru, Os, Rh, Ir, Ti, Co, Ni, Rb, Mn, V, or a mixture of any two or more thereof. The reducing agent is a hydroxycarboxylic acid, a salt of a hydroxycarboxylic acid, a borane, a borane adduct, a silane, a silane derivative, a borohydride, a primary alcohol, a secondary alcohol, a tertiary alcohol, formic acid, formaldehyde, a hydrazine, a mixture of any two or more thereof, or a salt thereof. The organic stabilizing agent is a thiol, an amine, a carboxylic acid, a polyhydric alcohol, a water-soluble polymer, or a mixture of any two or more thereof. The annealing is carried out at a temperature from 400 to 800° C.

Still another aspect is drawn to one or more devices comprising a substrate and a layer comprising the composite nanoparticle described above coated on at least a portion of a surface of the substrate.

In some aspect, the substrate is a metal. The layer includes a plurality of pores. Each pore has a diameter from about 10 nm to 300 nm.

Still another aspect is drawn to one or more capacitors comprising the substrate described above.

Still another aspect is drawn to methods of preparing the device described above. The method comprises preparing a solution or suspension including the composite nanoparticle, described above, applying the solution of the composite nanoparticle onto a substrate, and annealing the substrate.

In some aspects, the method further comprises removing the silica or alumina component from the annealed substrate. The silica or alumina component is removed by treating the annealed substrate with an alkaline solution. The alkaline solution is sodium hydroxide solution. In some aspects, the transition metal oxide is an oxide of Ru, Os, Rh, Ir, Ti, Co, Ni, Rb, Mn, V, or a mixture of any two or more thereof. The substrate is a metal or a metal oxide. In some aspects, the solution is applied onto the substrate by applying the solution onto the substrate using spin coating or dip coating.

Still another aspect is drawn to one or more devices comprising a substrate; and a porous layer comprising mineral oxide coated on at least a portion of a surface of the substrate.

The foregoing summary is illustrative only and is not intended to be in any way limiting. In addition to the illustrative aspects, embodiments, and features described above, further aspects, embodiments, and features will become apparent by reference to the following detailed description.

### BRIEF DESCRIPTIONS OF THE DRAWINGS

FIG. 1 is scanning electron microscopy (SEM) of silica particles prepared in Example 1.

FIG. 2 is SEM of composite nanoparticles prepared in Example 1.

FIG. 3 is X-ray diffractometry (XRD) of composite nanoparticles prepared in Example 1.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Supercapacitors (also known as electrochemical capacitors) have been actively researched. Supercapacitors can achieve capacitance several tens of times as large as that of conventional capacitors, by using an electrode material having a large surface area and a thin dielectric material. Also, supercapacitors have low equivalent series resistance (ESR), thereby improving power density, which has been a serious weak point in conventional capacitors.

Supercapacitors are largely classified into three types: electrochemical double-layer capacitors; (EDLC), pseudocapacitors, and hybrid capacitors. The three types of capacitors use a non-faradaic process, a faradaic process, and a combination thereof, respectively. Among the supercapacitors, the pseudocapacitors faradaically store charges through the transfer of the charges between an electrode and an electrolyte. This is achieved by electrical adsorption, a reduction-oxidation reaction, and intercalation. Such a faradaic process allows pseudocapacitors to achieve higher capacitance and higher energy density compared to those of the double-layer capacitors. As an electrode material for storing charges in a pseudocapacitor, a conductive polymer and a metal oxide may be used. Among the materials, research on the metal oxide as an electrode material available for the pseudocapacitor has been conducted due to its high conductivity. However, a currently used metal oxide, for example, ruthenium oxide, has a problem of increasing the fabrication cost of a pseudocapacitor due to its high cost.

One aspect is drawn to one or more composite nanoparticles comprising, but not limited to a nanoparticle of mineral oxide selected from silica and alumina and a shell of transition metal oxide at least partially surrounding the nanoparticle of mineral oxide.

The composite nanoparticles are nanoparticles of mineral oxides with a shell of a transition metal oxide. The shell of transition metal oxide is be formed around and attached to the mineral oxide via a physical adsorption or a chemical bond. Mineral oxides that may be used in the composite nanoparticles include, but are not limited to the oxides of aluminum, boron, silicon, germanium, and the like. Thus, in some embodiments, the composite nanoparticle is a nanoparticle of mineral oxide such as silica and alumina and a shell of transition metal oxide at least partially surrounding the nanoparticle of mineral oxide.

The transition metal oxides include, but are not limited to the oxides of metals from groups IIIB, IVB, VB, VIB, VIIB, VIII, IB, or IIB of the Periodic Table. Hence, the transition metal oxide may include, but is not limited to oxides of metals such as Ru, Os, Rh, Ir, Ti, Co, No, Rb, Mn and V, according to some embodiments. The transition metal oxide may include, for example, oxides of Ru, Ir and Co.

In some embodiments, the diameter of the composite nanoparticle is, but is not limited to, e.g., from about 10 nm to 900 nm as measured by TEM (Tunneling Electron Microscopy) or SEM (Scanning Electron Microscopy). In other embodiments, the diameter of the composite nanoparticle is from about 30 nm to 500 nm, or from about 50 nm to 300 nm, in yet other embodiments. In various other embodiments, the diameter of the nanoparticle of mineral oxide may be, but is not limited to, from about 5 nm to 900 nm, from about 20 nm to 300 nm, or from about 40 nm to 250 nm, as measured by TEM or SEM.

Composite nanoparticles may be used for fabricating conductive thin films, supercapacitor electrodes, thick or thin film resistors, ferroelectric thin films for fabrication of an integrated circuit, among various other uses known to those of skill in the art. The composite nanoparticles may also be used as catalysts. For example, the composite nanoparticles may form an electrocatalyst which catalyzes the oxidation or reduction occurring on the electrode of the fuel cell.

Another aspect is drawn to one or more methods of preparing the composite nanoparticle. The method may comprise, but is not limited to reacting a solution including a salt of transition metal with a nanoparticle of mineral oxide selected from silica and alumina in the presence of a reducing agent and an organic stabilizing agent, drying the resulting mixture, and annealing the dried mixture to form the composite nanoparticle.

Such methods include, reducing the salt of a transition metal to the corresponding elemental transition metal. The reducing may be accomplished by reaction of the transition metal with a reducing agent. The generated elemental transition metal is grown by adsorbing on or bonding to the nanoparticle of mineral oxide with assistance of the organic stabilizing agent. When the dried mixture is annealed, the organic stabilizing agent is decomposed into a gaseous compound, and the elemental transition metal on the nanoparticle of mineral oxide is oxidized into a transition metal oxide. In some embodiments, annealing may be carried out at a temperature, but not limited to, from about 300 to 950° C. For example, the annealing may be carried out at a temperature from about 400 to 900° C., or from about 450 to 850° C. The annealing may be carried out in an oxygenous atmosphere. The oxygenous atmosphere may comprise 5 to 100 volume % of oxygen, or for example, 5 to 25 volume % of oxygen. The oxygenous atmosphere may be air. Finally, the composite nanoparticle is obtained.

Nanoparticles of mineral oxide are commercially available in the form of powders or dispersions from various manufacturers, such as Degussa, Hanse Chemie, Nissan Chemicals, Clariant, H.C. Starck, Nanoproducts, or Nyacol Nano Technologies. Examples of commercially available silica nanoparticles include Aerosi® from Degussa, Ludox® from DuPont, Snowtex® from Nissan Chemicals, Levasil® from Bayer, or Sylysia® from Fuji Silysia Chemical. Also, examples of commercially available alumina nanoparticles include Nyacol® from Nyacol Nano Technologies or Disperal® from Sasol. To those skilled in the art, widely established different methods for using particles having different sizes, physical properties, and compositions, such as methods for a gas phase reaction or a solid phase reaction, for example, flame-hydrolysis (Aerosil process), a plasma method, an arc process, and a hot-wall reaction, and methods for a solution-based reaction, for example, an ion exchange method and a precipitation method, are known. The above mentioned methods may be specifically described with reference to many patents, such as European Patent Laid-Open Publication No. 1,236,765, U.S. Pat. Nos. 5,851,507, and 6,719,821, US Patent Publication No. 2004-178530, PCT Publication No. WO-A-05/026068 and European Patent Laid-Open Publication No. 1,048,617. For example, in order to prepare a silica nanoparticle, a widely known Stöber method, that is, hydration of tetraethyl ortho silicate (TEOS) in an ethanol solution including water and ammonia, may be used.

In some embodiments, the salt of transition metal may include, but is not limited to salts of metals from transition groups IIIB, IVB, VB, VIB, VIIB, VIII, IB, or IIB of the Periodic Table. The salt of transition metal may include, but is not limited to at least one selected from the group consisting of salts of Ru, Os, Rh, Ir, Ti, Co, No, Rb, Mn and V. Examples of the salt of transition metal may include, but is not limited to nitrates, halides (such as chlorides, bromides or iodides), acetates, or oxalates, etc.

The thickness of the shell of transition metal oxide in the composite nanoparticle may be appropriately controlled by changing the concentration of the solution including the salt of transition metal. The concentration of the transition metal salt in solution is from about 0.001 mol/L to 1 mol/L, in some embodiments. In other embodiments, the concentrate is from about 0.01 mol/L to 0.1 mol/L, or from about 0.05 mol/L to 0.5 mol/L, in yet other embodiments. Also, in some embodiments, the shell thickness of transition metal oxide of the composite nanoparticle may be appropriately controlled by repeatedly carrying out the reaction of the solution including the salt of transition metal with the nanoparticle of mineral oxide selected from silica and alumina in the presence of the reducing agent and the organic stabilizing agent. In some embodiments, the reaction of the solution including the salt of transition metal with the nanoparticle of mineral oxide is carried out at least twice.

The reducing agent may include, but is not limited to, hydroxycarboxylic acids and the salts thereof, boranes, borane adducts, silane derivatives, borohydrides, primary alcohols, secondary alcohols, tertiary alcohols, formic acid, formaldehyde, hydrazines and the salts thereof.

Examples of hydroxycarboxylic acids include, but are not limited to citric acid, lactic acid, malic acid, glycolic acid, mandelic acid and tartaric acid. Examples of boranes and borane adducts include, but is not limited to diboranes and trimethylamine borane. Examples of silane derivatives include, but is not limited to, compounds of the general formula SiH₍₄₋ₓ₎Rₓ. In SiH₍₄₋ₓ₎Rₓ, R represents C₆-C₁₂ aryl, C₁-C₁₂ alkyl, polyethers, or C₁-C₆ alkyl carboxylates. Examples of borohydrides include, but are not limited to sodium borohydride, lithium borohydrde, potassium borohydride, ammonium borohydride and tetramethylammonium borohydride. Examples of primary alcohols include, but are not limited to methanol, ethanol, propanol, butanol, pentanol, hexanol, heptanol, octanol, and the like. Examples of secondary alcohols include, but are not limited to isopropanol, butan-2-ol, pentan-2-ol, pentan-3-ol, and the like. Examples of tertiary alcohols include, but are not limited to t-butanol, neopentanol, and the like. Examples of hydrazines and the salts thereof include, but are not limited to hydrazine, hydrazine tartarate, hydrazine monohydrobromide, hydrazine monohydrochloride, hydrazine dichloride, hydrazine monooxalate and hydrazine sulfate.

Organic stabilizing agents include, but are not limited to any organic material that has a function of minimizing or preventing agglomeration of an elemental transition metal in a liquid, and optionally provides solubility or dispersibility to a composite nanoparticle. Also, the organic stabilizing agent may be thermally removed, and thus may be dissociated or decomposed from the surface of the composite nanoparticle under a certain conditions, such as heating.

As used herein, although the term “organic” represents the existence of carbon atom(s), the organic stabilizing agent may include, but is not limited to at least one non-metallic heteroatom, such as nitrogen, oxygen, sulfur, silicon, halogen, etc. For example, the organic stabilizing agent may include at least one group such a thiol, amine, carboxylic acid, polyhydric alcohol and water-soluble polymers.

Exemplary thiols include, but are not limited to butanethiol, pentanethiol, hexanethiol, heptanethiol, octanethiol, decanethiol and dodecanethiol. Examples of amines include, but are not limited to ethylamine, propylamine, butylamine, pentylamine, hexylamine, heptylamine, octylamine, nonylamine, decylamine and dodecylamine. Examples of carboxylic acids include, but are not limited to acetic acid, formic acid, and lactic acid. Examples of polyhydric alcohols include, but are not limited to ethylene glycol, polyethylene glycol, diethylene glycol, dipropylene glycol, 1,4-butanediol, 1,4-cyclohexanediol, 1,2-octanediol, 1,2-decanediol, 1,2-dodecanediol. Examples of soluble polymers include, but are not limited to carboxymethylcellulose, a homopolymer or a copolymer of acrylamide, polyacrylic acid, polyethylene oxide, polyvinyl alcohol, a polyvinyl alcohol-polyvinyl acetate copolymer, poly(N-vinylpyrrolidone), polyhydroxyethyl acrylate.

Still another aspect is drawn to one or more substrates including, but not limited to, a layer of the composite nanoparticle described above coated on at least a portion of the surface of the substrate.

In some embodiments, the substrate is a transition metal oxide. In other embodiments, the substrate is a material other than a transition metal oxide and a transition metal oxide coats at least a portion of the substrate. Accordingly, compared to a substrate made of transition metal oxide, the substrate of the present disclosure may be more economical because the consumed amount of transition metal oxide can be reduced. The substrate may be, but is not limited to metal or metal oxide. For example, the substrate may be, but is not limited to aluminum or tantalum used for an electrode of a capacitor, or may be, but is not limited to silver, gold, platinum, palladium, or oxide thereof used for an electrode of a fuel cell.

In some embodiments, the silica or alumina component is removed from the substrate. For example, the transition metal oxide layer on the substrate may include a plurality of pores. Each pore may have, but is not limited to a diameter of from about 10 nm to 300 nm, from about 20 nm to 250 nm, or from about 30 nm to 200 nm, as measured by TEM or SEM. The porosity of the transition metal oxide layer may be controlled by changing the size of a silica or alumina nanoparticle as required.

Another aspect is drawn to one or more methods of preparing the substrate. The method may include, but is not limited to preparing a solution or suspension including the composite nanoparticle and applying the solution or suspension of the composite nanoparticle onto a substrate. The methods may also include annealing the substrate. The solvent for making the solution or suspension may be water or an organic solvent or a mixture thereof. The solvent may be included in an amount of 60 to 99% by weight, for example, 70 to 99% by weight, or 70 to 80% by weight based on the total weight of the solution or suspension. The organic solvent may include, but is not limited to alcohols such as methanol, ethanol and propanol, ethers such as diethyl ether and tetrahydrofurane, and ketones such as acetone, benzene, toluene, xylene, mesitylene, cyclohexane, cyclopentane, pentane, hexane, heptane, octane, acetone, isobutyl methyl ketone, diethyl ketone, diethyl ether, tert-butyl methyl ether, tert-butyl ethyl ether, tetrahydrofuran, dioxane, ethyl acetate, methyl acetate, dimethylformamide, dimethyl sulfoxide, acetonitrile, chloroform, dichloromethane, methylchloroform.

In another aspect, a capacitor is provided, including the substrate coated with a composite nanoparticle. When a porous layer of transition metal oxide is coated on a metal substrate, the specific surface of the substrate is increased. Accordingly, the substrate including the porous layer of transition metal oxide exhibits improved electrical efficiency, when compared to a substrate made of transition metal oxide in the same amount, or a substrate coated with a simple transition metal oxide layer.

Also, provided is a method of fabricating the device. The method includes, but is not limited to, preparing a solution or suspension including the composite nanoparticle, applying the solution or suspension of the composite nanoparticle onto a substrate, and annealing the substrate.

In some embodiments, the method of fabricating the device may also include removing the silica or alumina component from the annealed substrate. The silica or alumina component may be removed by treating the annealed substrate with an alkaline solution. Exemplary alkaline solutions include strongly basic solutions such as, but not limited to, sodium hydroxide and potassium hydroxide solutions. Also, the solution may be applied onto the substrate by applying the solution or suspension including the composite nanoparticle onto the substrate using a spin coating or a dip coating.As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular temn.

The embodiments, illustratively described herein may suitably be practiced in the absence of any element or elements, limitation or limitations, not specifically disclosed herein. Thus, for example, the terns “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed invention. Additionally the phrase “consisting essentially of” will be understood to include those elements specifically recited and those additional elements that do not materially affect the basic and novel characteristics of the claimed invention. The phrase “consisting of” excludes any element not specifically specified.

In general, “substituted” refers to a group, as defined below (e.g., an alkyl or aryl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls(oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

Alkyl groups include straight chain and branched alkyl groups having from 1 to 20 carbon atoms or, in some embodiments, from 1 to 12, 1 to 8, 1 to 6, or 1 to 4 carbon atoms. Alkyl groups further include cycloalkyl groups. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above. Where the term haloalkyl is used, the alkyl group is substituted with one or more halogen atoms.

Alkenyl groups include straight and branched chain and cycloalkyl groups as defined above, except that at least one double bond exists between two carbon atoms. Thus, alkenyl groups have from 2 to about 20 carbon atoms, and typically from 2 to 12 carbons or, in some embodiments, from 2 to 8, 2 to 6, or 2 to 4 carbon atoms. In some embodiments, alkenyl groups include cycloalkenyl groups having from 4 to 20 carbon atoms, 5 to 20 carbon atoms, 5 to 10 carbon atoms, or even 5, 6, 7, or 8 carbon atoms. Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl, among others. Representative substituted alkenyl groups may be mono-substituted or substituted more than once, such as, but not limited to, mono-, di- or tri-substituted with substituents such as those listed above.

Aryl groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. Although the phrase “aryl groups” includes groups containing fused rings, such as fused aromatic-aliphatic ring systems (e.g., indanyl, tetrahydronaphthyl, and the like), it does not include aryl groups that have other groups, such as alkyl or halo groups, bonded to one of the ring members. Rather, groups such as tolyl are referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl groups, which may be substituted with substituents such as those listed above.

As used herein, “halogen” refers to F, Cl, Br, or I.

As used herein, ammonium, or quaternary amine, refers to groups or ions having the following structure, ⁺NR^{a}R^{b}R^{c}R^{d}, where R^{a}, R^{b}, R^{c}, and R^{d} are independently selected from H and alkyl groups. Thus, all of the R^{a-d} groups may be the same or different. Alkyl ammonium refers to ammonium groups having one, two, three, or four alkyl groups, while tetralkylammonium refers to ammonium groups having four alkyl groups. Mixed alkyl ammoniums are those ammonium having two, three, or four alkyl groups where at least one of the alkyl groups is different from the other alkyl groups.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present embodiments, thus generally described, will be understood more readily by reference to the following examples, which are provided by way of illustration and are not intended to be limiting of the present technology in any way.

### EXAMPLES

### Example 1

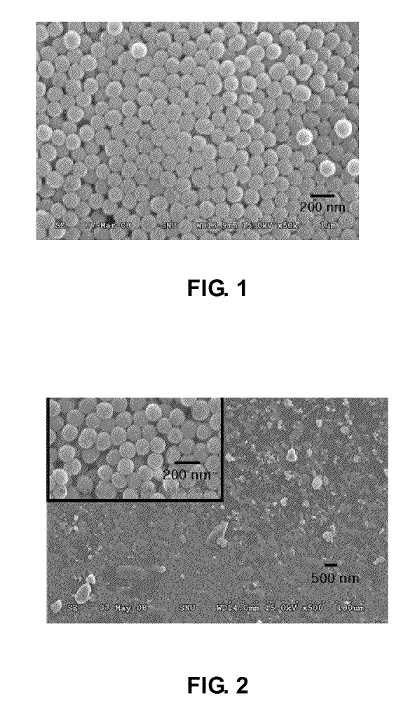

Tetraethyl orthosilicate (1.0 ml), and 25 wt % ammonia water (2.5 ml) are slowly added to ethanol (20 ml). The mixture is then stirred for 20 hours at room temperature to obtain a colloidal suspension of silica. From the suspension, silica particles are centrifuged and washed with ethanol three times. As shown in FIG. 1, the silica particles have diameters of about 120 nm as observed by SEM.

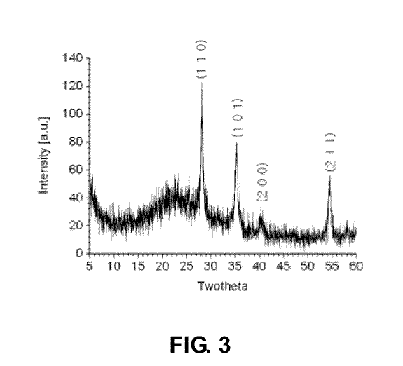

RuCl₃ (10 mmol) is dissolved in a water-ethanol solution (v/v=1:7) including citric acid. The molar ratio of metal ion to citric acid is 1:2. Then, polyethylene glycol (0.2 g, molecular weight: 8000) is added, followed by stirring for one hour, to obtain a solution. To the solution, the silica particles dispersed in 5 mL of ethanol (20 mg/mL) are added with stirring. After further stirring the suspension for 3 hours, the resulting particles are centrifugally separated. Separated particles are dried at 120° C. for 1 hour. Dried particles are again dispersed in 30 mL of triethylene glycol and the mixture is stirred at 100° C. for 10 minutes and further stirred at 250° C. for 2 hours. The mixture is allowed to cool to ambient temperature, centrifugally separated, and washed with ethanol three times. Obtained mixture is centrifugally separated and dried at 120° C. for 1 hour. Dried sample is annealed at 500° C. for 2 hours, and then annealed at 600° C. for 1 hour to form composite nanoparticles. As shown in FIG. 2, the composite nanoparticles have diameters of about 130 to 140 nm as observed by SEM. As shown in FIG. 3, the composite nanoparticles show X-ray diffractometry (XRD) peaks characteristic of RuO₂ with Cu Kα radiation.

### Example 2

Composite nanoparticles are obtained in the same manner as described in Example 1, except that IrBr₃ is used instead of RuCl₃.

### Example 3

Composite nanoparticles are obtained in the same manner as described in Example 1, except that MnCl₂ is used instead of RuCl₃.

### Example 4

Tetraethyl orthosilicate (1.0 ml) and 25 wt % ammonia water (2.5 ml) are slowly added to ethanol (20 ml). The mixture is then stirred for 20 hours at room temperature to obtain a colloidal suspension of silica. From the suspension, silica particles are centrifuged and washed by ethanol three times.

RuCl₃ (10 mmol) is dissolved in a water-ethanol solution (v/v=1:7) including citric acid. The molar ratio of metal ion to citric acid is 1:2. Then, polyethylene glycol (0.2 g, molecular weight: 8000) is added, followed by stirring for one hour, to obtain a solution. To the solution, the silica particles dispersed in 5 mL of ethanol (20 mg/mL) are added with stirring. After further stirring the suspension for 3 hours, the resulting particles are centrifugally separated. Dried particles are again dispersed in 30 mL of triethylene glycol and the mixture is stirred at 100° C. for 10 minutes and further stirred at 250° C. for 2 hours. The mixture is allowed to cool to ambient temperature, centrifugally separated, and washed with ethanol three times. Obtained suspension is spin-coated on an aluminum substrate (length 1.0 cm×width 0.5 cm×thickness 0.05 cm) and dried at 120° C. for 1 hour. The dried substrate is annealed at 500° C. for 2 hours and then annealed at 600° C. for 1 hour to form a metal substrate coated with nanoparticles.

The composite nanoparticle according to present disclosure may be used, but is not limited to, for fabricating a conductive thin film, an electrode of a supercapacitor, resistance of a thick/thin film, and a ferroelectric thin film in fabrication of an integrated circuit, and may be used as a catalyst, such as an electrocatalyst, in a fuel cell.

### EQUIVALENTS

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A composite nanoparticle comprising:
a nanoparticle of mineral oxide; and
a shell of a transition metal oxide,
wherein, the mineral oxide is silica, alumina, or a mixture thereof and the shell of transition metal oxide at least partially surrounds the nanoparticle of mineral oxide.

2. The composite nanoparticle of claim 1, wherein the transition metal oxide is an oxide of Ru, Os, Rh, Ir, Ti, Co, Ni, Rb, Mn, V, or a mixture of any two or more thereof.

3. The composite nanoparticle of claim 1, wherein the diameter of the composite nanoparticle is from about 50 nm to 500 nm.

4. A method of preparing the composite nanoparticle of claim 1, comprising:
reacting a solution comprising a salt of a transition metal with a nanoparticle of the mineral oxide in the presence of a reducing agent and an organic stabilizing agent;
drying the resulting mixture to form a dried mixture; and
annealing the dried mixture to form the composite nanoparticle.

5. The method of claim 4, wherein the salt of the transition metal is a salt of Ru, Os, Rh, Ir, Ti, Co, Ni, Rb, Mn, V, or a mixture of any two or more thereof.

6. The method of claim 4, wherein the reducing agent is a hydroxycarboxylic acid, a salt of a hydroxycarboxylic acid, a borane, a borane adduct, a silane, a silane derivative, a borohydride, a primary alcohol, a secondary alcohol, a tertiary alcohol, formic acid, formaldehyde, a hydrazine, or a salt thereof, or a mixture of any two or more thereof.

7. The method of claim 4, wherein the organic stabilizing agent is a thiol, an amine, a carboxylic acid, a polyhydric alcohol, a water-soluble polymer, or a mixture of any two or more thereof.

8. The method of claim 4, wherein the annealing is carried out at a temperature from 400 to 800° C.

9. A device comprising:
a substrate; and
a layer comprising the composite nanoparticle according to claim 1 coated on at least a portion of a surface of the substrate.

10. The device of claim 9, wherein the substrate is a metal.

11. The device of claim 9, wherein the layer includes a plurality of pores, each pore having a diameter from about 10 nm to 300 nm.

12. A capacitor comprising the device according to claim 9.

13. A method of preparing the device of claim 9 comprising:
preparing a solution or suspension including the composite nanoparticle according to claim 1;
applying the solution or suspension of the composite nanoparticle onto a substrate; and
annealing the substrate.

14. The method of claim 13, further comprising removing the silica or alumina component from the annealed substrate.

15. The method of claim 14, wherein removing the silica or alumina component comprises treating the annealed substrate with an alkaline solution.

16. The method of claim 15, wherein the alkaline solution is sodium hydroxide solution.

17. The method of claim 13, wherein the transition metal oxide is an oxide of Ru, Os, Rh, Ir, Ti, Co, Ni, Rb, Mn, V, or a mixture of any two or more thereof.

18. The method of claim 13, wherein the substrate is a metal or a metal oxide.

19. The method of claim 13, wherein applying the solution or suspension onto the substrate comprises applying the solution or suspension onto the substrate using spin coating or dip coating.

20. A device comprising:
a substrate; and
a porous layer comprising mineral oxide coated on at least a portion of a surface of the substrate.
